(19) United States
(12) Patent Application Publication
(10) Pub. No.: US 2026/0303984 A1
(43) Pub. Date: Oct. 1, 2026

(54) IMAGE PROCESSING APPARATUS AND IMAGE PROCESSING METHOD, AND IMAGE CAPTURE APPARATUS

(71) Applicant: CANON KABUSHIKI KAISHA, Tokyo (JP)

(72) Inventor: MASAHIRO TAKAYAMA, Tokyo (JP)

(21) Appl. No.: 19/576,967

(22) Filed: Mar. 24, 2026

(30) Foreign Application Priority Data
Mar. 31, 2025 (JP) 2025-059134

(51) Int. Cl. H04N 23/84; H04N 23/88

(52) U.S. Cl. CPC H04N 23/843; H04N 23/88

(57) ABSTRACT

Disclosed is an apparatus that executes, on second image data obtained by executing demosaic processing on first image data, adjustment processing using a first correction value to obtain third image data, wherein the first correction value is not dependent on the second image data. The apparatus estimates, based on the third image data, information relating to an ambient illuminant of a capturing scene of the first image data. The apparatus obtains, based on the estimated information relating to the ambient illuminant and on the second image data, a second correction value to be used for execution of adjustment processing on the second image data.

### BACKGROUND

### Field of the Technology

The aspect of the embodiments relates to an image processing apparatus and an image processing method, as well as an image capture apparatus, and particularly relates to a white balance adjustment technique.

### Description of the Related Art

An automatic white balance adjustment function is used for image processing apparatuses such as an image capture apparatus. The automatic white balance adjustment function is a function of estimating achromatic regions in an image, and adjusting the overall tone of the image such that the RGB values of the estimated achromatic regions are equal.

For the purpose of improving the accuracy of the automatic white balance adjustment function, the use of a machine learning model has been proposed. Japanese Patent Laid-Open No. 2021-182672 uses a machine learning model in order to estimate the color temperature of an illuminant from a region having a specific color (e.g., skin color) that is included in a region of a specific object such as a person detected from the image.

However, with the method described in Japanese Patent Laid-Open No. 2021-182672, the accuracy of the white balance adjustment is reduced in a case where the region of the specific object and the region of the specific color are detected with low accuracy, or cannot be detected.

### SUMMARY

According to an aspect of the embodiments, there is provided an apparatus comprising one or more processors that execute a program stored in a memory and thereby cause the one or more processors to: execute, on second image data obtained by executing demosaic processing on first image data, adjustment processing using a first correction value to obtain third image data, wherein the first correction value is not dependent on the second image data; estimate, based on the third image data, information relating to an ambient illuminant of a capturing scene of the first image data; and obtain, based on the estimated information relating to the ambient illuminant and on the second image data, a second correction value to be used for execution of adjustment processing on the second image data.

Features of the disclosure will become apparent from the following description of embodiments with reference to the attached drawings. The following description of embodiments is given by way of example.

### BRIEF DESCRIPTION OF THE DRAWINGS

The accompanying drawings, which are incorporated in and constitute a part of the specification, illustrate embodiments of the disclosure, and together with the description, serve to explain the principles of the embodiments.

FIG. 1 is a block diagram showing an example of a functional configuration of an electronic camera, which is an example of an image processing apparatus according to an embodiment of the disclosure.

FIG. 2 is a block diagram showing an example of a functional configuration of an image processing unit according to the embodiment.

FIG. 3 is a block diagram showing an example of a functional configuration of a DL unit according to the embodiment.

FIG. 4 is a diagram illustrating a neural network according to the embodiment.

FIG. 5 is a flowchart showing the detailed processing executed by a WB control unit according to a first embodiment.

FIGS. 6A to 6C are diagrams showing white point detection ranges according to an embodiment.

FIG. 7 is a flowchart showing the detailed processing executed by a WB control unit according to a second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Note that the following describes a digital camera as an example of an image processing apparatus according to an embodiment. However, an image capturing function is not essential to the image processing apparatus according to the disclosure. The image processing apparatus according to the disclosure may be any electronic device including one or more arithmetic circuits or processors. Such electronic devices include a video camera, a computer device (a personal computer, a tablet computer, a media player, a PDA, etc.), a smartphone, a smart watch, a game console, a robot, a drone, and a drive recorder. These are merely examples, and the image processing apparatus according to the embodiment may be any other electronic device.

### First Embodiment

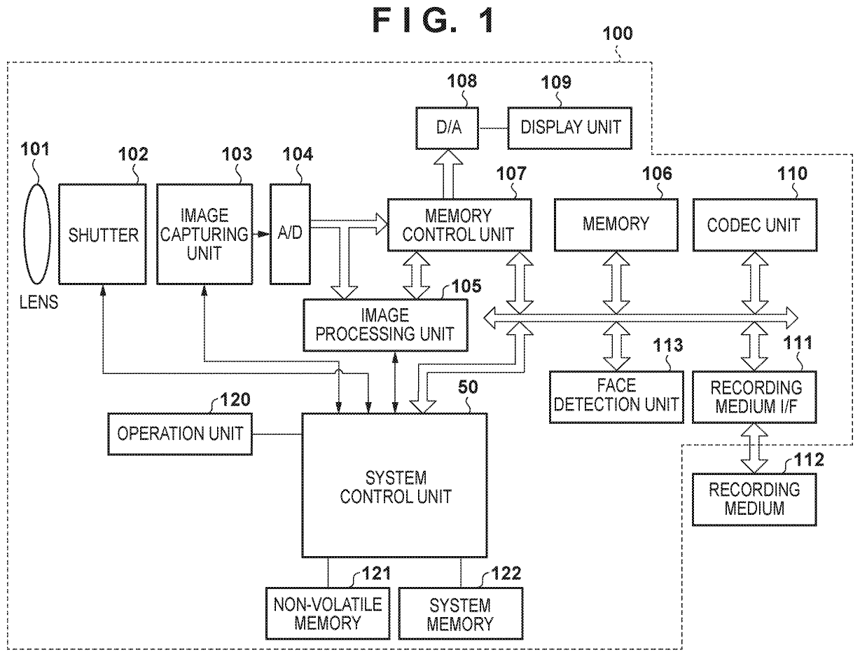

FIG. 1 is a block diagram showing an example of a functional configuration of an electronic camera 100 as an image processing apparatus according to an embodiment.

A lens group 101 is an optical system that forms an optical image of an object on an image capturing plane of an image capturing unit 103. The lens group 101 includes a fixed lens and a movable lens. The movable lens may include, in addition to a focus lens, a zoom lens, a lens for image blur correction, and so forth. The operation of the movable lens is controlled by a system control unit 50.

A shutter 102 is a mechanical shutter, and also functions as an aperture. Note that an aperture may be provided separately from the shutter 102. The operation of the shutter 102 is controlled by the system control unit 50.

The image capturing unit 103 includes an image sensor, and peripheral circuits (a clock signal supply circuit, a scanning circuit, a readout circuit, and so forth) necessary for the operation of the image sensor. The image sensor may be a known CCD or CMOS color image sensor including color filters based on a primary-color Bayer array, for example. The image sensor includes a pixel array in which a plurality of pixels are arranged two-dimensionally, and a peripheral circuit for reading out signals from the pixels. Each pixel accumulates electric charges corresponding to the amount of incident light through photoelectric conversion. By reading out, from each of the pixels, a signal having a voltage corresponding to the amount of electric charges accumulated during an exposure period, a group of pixel signals (analog image signals) representing an object image formed on the imaging plane can be obtained.

An A/D conversion unit 104 converts the analog image signal read out from the image capturing unit 103 into a digital image signal (image data). The image data is supplied to an image processing unit 105, or temporarily stored in a memory 106 via a memory control unit 107.

The image processing unit 105 applies predetermined image processing to the image data output by the A/D conversion unit 104, and image data read out from a recording medium 112, thus generating a signal and image data corresponding to the use, and obtaining and/or generating various types of information. The image processing unit 105 may be, for example, a dedicated hardware circuit such as an application specific integrated circuit (ASIC) designed to achieve a specific function. Alternatively, the image processing unit 105 may be configured to achieve a specific function by a processor such as a digital signal processor (DSP) or a graphics processing unit (GPU) executing software. The image processing unit 105 outputs the obtained or generated information and data to the system control unit 50 and the memory control unit 107 or the like according to the use.

The image processing applied to the image data by the image processing unit 105 may include, for example, pre-processing, color interpolation processing, correction processing, detection processing, data processing, evaluation value calculation processing, special effects processing, and so forth.

Pre-processing may include signal amplification, reference level adjustment, defective pixel correction, and so forth.

Color interpolation processing is executed in a case where the image sensor is provided with color filters, and interpolates the values of color components not included in the individual pieces of pixel data constituting image data. Color interpolation processing is also called demosaic processing.

Correction processing may include processing such as white balance adjustment, tone correction, correction of image degradation resulting from optical aberrations of the lens group 101, correction of the influence of vignetting of the lens group 101, and color correction.

Detection processing may include detection of feature regions (e.g., a face region and a body region) and motion thereof, person recognition processing, and so forth.

Data processing may include processing such as region clipping (trimming), combining, scaling, encoding and decoding, and header information generation (data file generation), or the like. Generation of image data for display and image data for recording is also included in data processing. Note that encoding and decoding may be performed by a codec unit 110.

Evaluation value calculation processing may include processing such as generation of signals and evaluation values used for auto focus detection (AF), and generation of evaluation values used for auto exposure control (AE).

Special effects processing may include processing such as application of blur effect, changing of tone, and relighting, or the like.

Note that these are merely examples of processing that can be applied by the image processing unit 105, and are not intended to limit the processing applied by the image processing unit 105.

Note that the electronic camera 100 is capable of capturing still images and moving images. Although treatment of audio is not particularly described in the specification, the electronic camera 100 also records audio in parallel with capturing a moving image, and generates moving image data with audio. The audio-related processing necessary for generating the moving image data is executed by the image processing unit 105 or the system control unit 50.

The memory 106 is used as a buffer memory that temporarily stores image data that is output by the A/D conversion unit 104, image data read out from the recording medium 112, image data for recording, and so forth. The memory 106 is also used as a work memory that temporarily stores image data to which image processing is applied by the image processing unit 105, and intermediate data. Part of the memory 106 is also used as a video memory for a display unit 109. By writing image data for display into the region of the video memory, an image based on the image data for display is displayed on the display unit 109.

The memory control unit 107 controls reading/writing of data from and to the memory 106. A D/A conversion unit 108 converts the image data for display stored in the region of the video memory of the memory 106 into an analog signal suited for display on the display unit 109, and outputs the analog signal to the display unit 109.

The display unit 109 includes a display apparatus such as an LCD, and displays a captured image, an image read out from the recording medium 112, a live-view image, and so forth. In addition, the display unit 109 displays information about the electronic camera 100, various settings, information relating to an image being displayed, a user interface such as a menu screen, and so forth.

The codec unit 110 performs encoding and decoding for the image data stored in the memory 106. The codec unit 110 is compliant with a known encoding scheme such as JPEG or MPEG that can be applied to still image data and moving image data. Note that encoding and decoding may be performed by the image processing unit 105.

A recording medium I/F 111 mechanically and electrically connects, for example, a removable recording medium 112 such as a semiconductor memory card or a card-type hard disk to the electronic camera 100. A face detection unit 113 analyzes image data, and detects the face region included in the image represented by the image data. The detection of the face region may be performed by the image processing unit 105. Also, a configuration for detecting a specific region other than the face may be additionally provided.

The system control unit 50 is, for example, a processor (a CPU, an MPU, a microprocessor, or the like) capable of executing a program. The system control unit 50 controls operations of the units of the electronic camera 100 by reading, into a system memory 122, a program stored in a non-volatile memory 121, and executing the program, thus achieving the functions of the electronic camera 100.

The non-volatile memory 121 is electrically rewritable, for example. The non-volatile memory 121 stores a program that is executed by the system control unit 50, various set values of the electronic camera 100, GUI data, and so forth.

The system memory 122 is a volatile memory such as a DRAM. The system memory 122 temporarily stores a program that is executed by the system control unit 50, and constants, variables, parameters, and the like that are used by the system control unit 50 during execution of the program.

An operation unit 120 is a generic term for input devices (a button, a switch, a dial, etc.) provided for the user to input various instructions to the electronic camera 100. The input devices constituting the operation unit 120 have names corresponding to the functions assigned thereto. For example, the operation unit 120 includes a release switch, a moving image recording switch, a capturing mode selection dial for selecting an image-capturing mode, a menu button, a direction key, an enter key, and so forth. The release switch is a still image recording switch, and the system control unit 50 recognizes a half-pressed state of the release switch as a capturing preparation instruction, and recognizes a fully-pressed state thereof as a capturing start instruction. Upon detecting the capturing preparation instruction, the system control unit 50 executes an operation for preparing capturing of a still image, such as an AE operation or an AF operation. Upon detecting the capturing start instruction, the system control unit 50 controls the operation of the shutter 102 in accordance with a capturing condition determined in the AE operation, to expose the image capturing unit 103. Then, the system control unit 50 generates an image file storing still image data for recording from an analog image signal obtained through capturing, and controls a series of operations until the image file is recorded in the recording medium 112.

In addition, the system control unit 50 recognizes an instruction to start recording of a moving image when the moving image recording switch is pressed in a capturing standby state, and recognizes a recording stop instruction when the moving image recording switch is pressed during recording of a moving image. Upon detecting the recording start instruction, the system control unit 50 performs moving image capturing at a predetermined frame rate while performing the AE operation and the AF operation. Then, the system control unit 50 generates an image file storing moving image data for recording from an analog image signal at the predetermined frame rate obtained through capturing, and controls a series of operations until the image file is recorded in the recording medium 112.

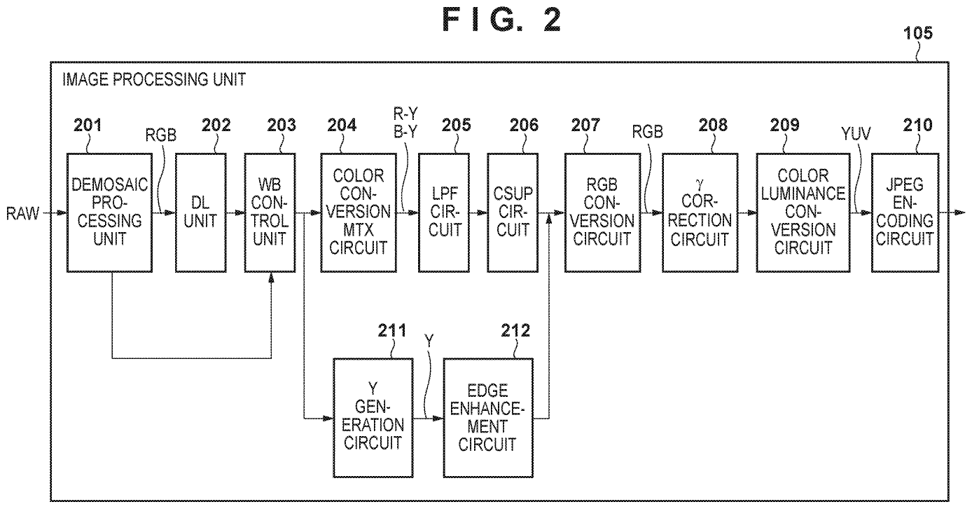

FIG. 2 is a diagram in which a series of image processing executed by the image processing unit 105 in the embodiment is represented using functional blocks. Note that the functional blocks are represented for descriptive purpose, and the functions of a plurality of functional blocks may be performed by one integrated circuit. One or more of the functional blocks may be implemented by a processor executing a program. FIG. 2 shows functional blocks relating to the processing necessary for describing the embodiment, among the processing that can be executed by the image processing unit 105.

A demosaic processing unit 201 executes demosaic processing (also referred to as Debayer processing, synchronization processing) on image data output from the A/D conversion unit 104. In one embodiment, image data obtained using an image sensor provided with one color filter for each pixel has only one color component for each of the individual pixels. Such a format of image data will be called a “RAW format” here. Demosaic processing is processing for adding a color component missing from each pixel for image data obtained using an image sensor provided with a color filter. By applying demosaic processing to the image data, the image data can be handled as color image data.

The demosaic processing unit 201 outputs the image data that has undergone the processing to a deep learning (DL) unit 202 and a WB control unit 203.

Deep learning (DL) is a technique for neural network machine learning. The DL unit 202 trains a neural network and performs inference processing using a trained neural network. Although the details will be described later, the DL unit 202 generates input image data from the image data output from the demosaic processing unit 201, infers an ambient illuminant of a capturing scene represented by the input image data, and outputs illuminant estimation information. The illuminant estimation information may take any form that enables specifying the type or color temperature of the ambient illuminant. For example, the illuminant estimation information may be a likelihood of each illuminant type.

The WB control unit 203 calculates a white balance (WB) correction value based on the image data output from the demosaic processing unit 201 and the illuminant estimation information output from the DL unit 202. Then, the WB control unit 203 adjusts the white balance by applying the calculated WB correction value to the color components of the image data. The method for calculating the WB correction value will be described later. The WB control unit 203 outputs the image data that has undergone white balance adjustment to a color conversion matrix (MTX) circuit 204 and a Y generation circuit 211.

The color conversion matrix (MTX) circuit 204 multiplies the image data that has undergone white balance adjustment, which is output by the WB control unit 203, a color gain, and converts the image data in an RGB format into two pieces of color difference signal data R-Y and B-Y. A low-pass filter (LPF) circuit 205 limits the band of the color difference signal data R-Y and B-Y. A chroma suppress (CSUP) circuit 206 suppresses a false color signal of a saturated portion of the color difference signal data whose band has been limited by the LPF circuit 205.

The Y generation circuit 211 generates luminance signal data Y from the image data that has undergone white balance adjustment. An edge enhancement circuit 212 applies edge enhancement processing to the luminance signal data Y.

An RGB conversion circuit 207 converts, into image data in an RGB format, the image data in a YUV format that is composed of the color difference signal data R-Y and B-Y output from the CSUP circuit 206 and the luminance signal data Y output from the edge enhancement circuit 212.

A gamma (γ) correction circuit 208 performs gamma correction processing on the image data output by the RGB conversion circuit 207. Gamma correction processing is tone correction processing in accordance with predetermined γ properties. The image data on which gamma correction processing has been performed is output to a color luminance conversion circuit 209.

The color luminance conversion circuit 209 converts the image data in an RGB format into image data in a YUV format in order to encode the former data in a JPEG format. A JPEG encoding circuit 210 encodes the image data output by the color luminance conversion circuit 209, and generates an image file in a JPEG format. The data of the generated image file is stored in the memory 106, and thereafter recorded in the recording medium 112. Note that the image file in a JPEG format may be generated by the codec unit 110 rather than the JPEG encoding circuit 210 (image processing unit 105).

Although not shown in FIG. 2, other correction processing such as defective pixel correction, and correction of image degradation resulting from optical aberrations and vignetting of the lens group 101 is actually applied by the image processing unit 105.

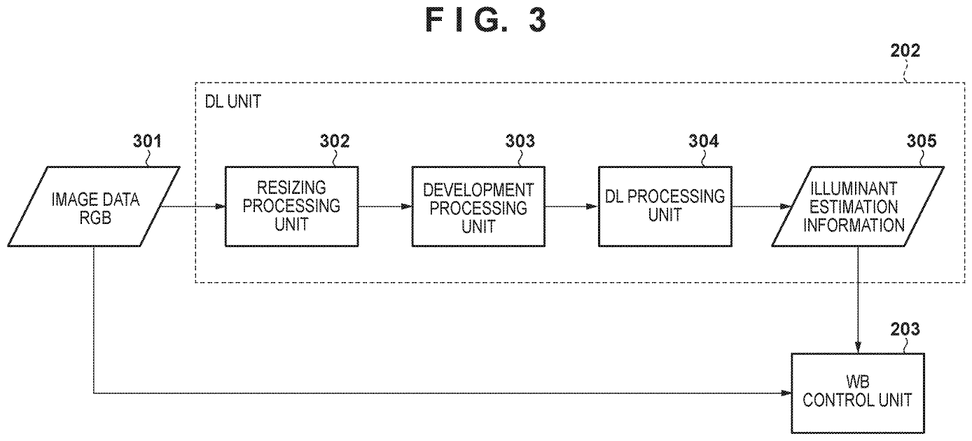

FIG. 3 is a diagram in which a series of image processing executed by the DL unit 202 in the embodiment is represented using functional blocks.

Reference numeral 301 denotes image data in an RGB format that is output by the demosaic processing unit 201. A resizing processing unit 302 resizes the image data 301 to a resolution of an image that is input to a machine learning model (neural network) used in a DL processing unit 304. Usually, resizing is reduction.

A development processing unit 303 performs development processing for illuminant estimation on the resized image data. The development processing performed here includes at least white balance adjustment processing among the image processing performed downstream of the DL unit 202 in FIG. 2.

The white balance adjustment processing performed in the development processing for illuminant estimation uses a fixed WB correction value that is not dependent on image data (i.e., is not auto white balance adjustment processing). The fixed WB correction value may be a WB correction value assuming, for example, a specific ambient illuminant (e.g., sunlight (daylight)). Therefore, for an image captured under an ambient illuminant that has a color temperature different from that of the specific ambient illuminant, the influence of the ambient illuminant remains in the tone of the image represented by the image data that has undergone development processing.

For example, in a case where the specific ambient illuminant is sunlight (daylight), an image captured under a low color temperature illuminant such as an electric bulb is generally reddish even after development processing. An image captured under a high color temperature illuminant such as a cloudy sky or a shade environment under a clear sky is generally bluish even after development processing. By executing development processing using the fixed WB correction in this manner, the influence of the illuminant color remains in the entire image that has undergone development processing. Accordingly, it is possible to accurately estimate the color temperature of the ambient illuminant from an image, regardless of the presence of the region of a specific object or a specific color. In a case where a fixed WB correction value assuming a specific ambient illuminant is used, an image with an appropriate tone can be obtained for an image captured under the specific ambient illuminant. Therefore, if the tone of an image is appropriate, it can be estimated that the image was captured under that specific ambient illuminant.

During the learning phase, the DL processing unit 304 uses input data and correct answer data to train a neural network through supervised learning, for example. During the inference phase, the DL processing unit 304 supplies input data to a trained neural network, and obtains illuminant estimation information from the neural network. Note that training may be performed by an apparatus different from the electronic camera 100. Here, the DL processing unit 304 obtains the illuminant estimation information, using data representing a trained neural network stored in advance in the non-volatile memory 121.

Here, the neural network is trained so as to output at least one of an illuminant color temperature, Δuv (color deviation), and an illuminant type as illuminant estimation information 305. Note that the neural network may be configured and trained so as to also output a reliability indicating a likelihood of the estimated result. The illuminant estimation information 305 is output to the WB control unit 203, and used for white balance adjustment processing.

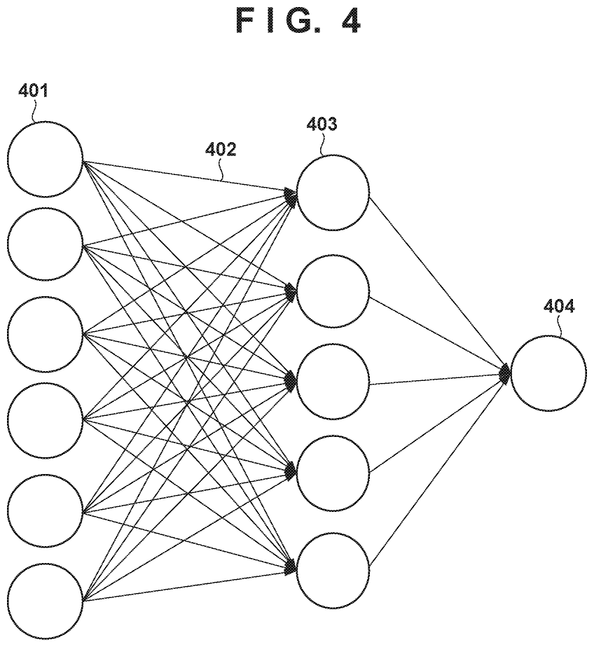

FIG. 4 is a schematic diagram of a multilayer perceptron (MLP) as an example of the neural network that can be used by the DL processing unit 304. Reference numeral 401 denotes a plurality of neurons constituting an input layer, reference numeral 403 denotes a plurality of neurons constituting an intermediate layer (hidden layer), and reference numeral 404 denotes one neuron constituting an output layer. A plurality of intermediate layers may be present. Each of the neurons 403 constituting the intermediate layer has a link 402 that receives a value obtained by multiplying outputs of all of the neurons constituting one previous layer by a weight. Training of the neural network is processing for adjusting the weight of each of the links 402 such that the difference between the output of the output layer 404 and the correct answer data is smaller than a predetermined value.

Although FIG. 2 assumes a case where illuminant estimation is performed during still image capturing (recording), illuminant estimation may be performed for frame images of a moving image captured for live-view display in the capturing standby state. In this case, white balance adjustment processing on still image data is performed using a result of illuminant estimation performed immediately before the still image capturing. Note that a case where illuminant estimation is performed in parallel with live-view display is the same as the above-described case in that a fixed WB correction value is used for development processing for illuminant estimation. Since auto white balance adjustment processing is executed on a moving image generated for live-view display, the input data used by the DL processing unit 304 may have a tone different from that of a moving image displayed in a live view.

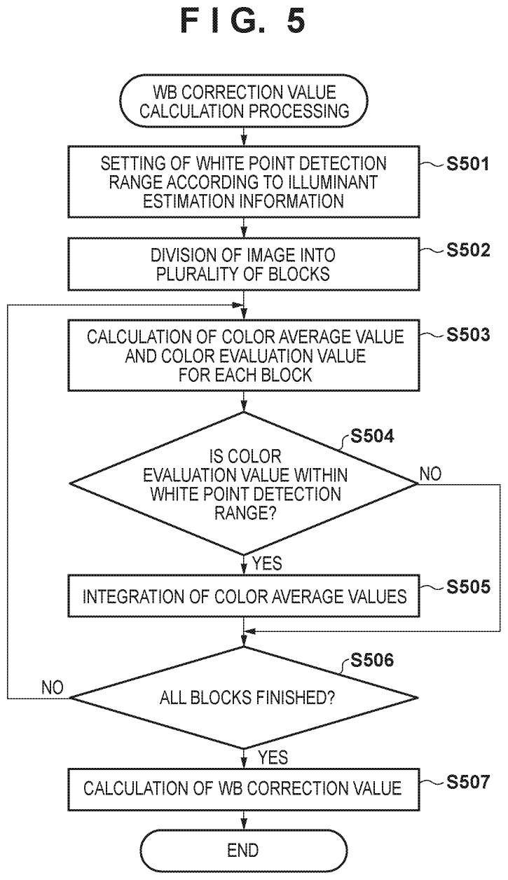

Next, the details of the processing for calculating the WB correction value performed in the WB control unit 203 will be described with reference to the flowchart shown in FIG. 5. Note that, as described above, the WB control unit 203 is a schematic representation of the function of the image processing unit 105. Accordingly, the processing described below as the operation of the WB control unit 203 is actually executed by the image processing unit 105.

In S501, the WB control unit 203 sets a color range to be detected as a white region in image data that is supplied from the demosaic processing unit 201, based on the illuminant estimation information obtained by the DL unit 202.

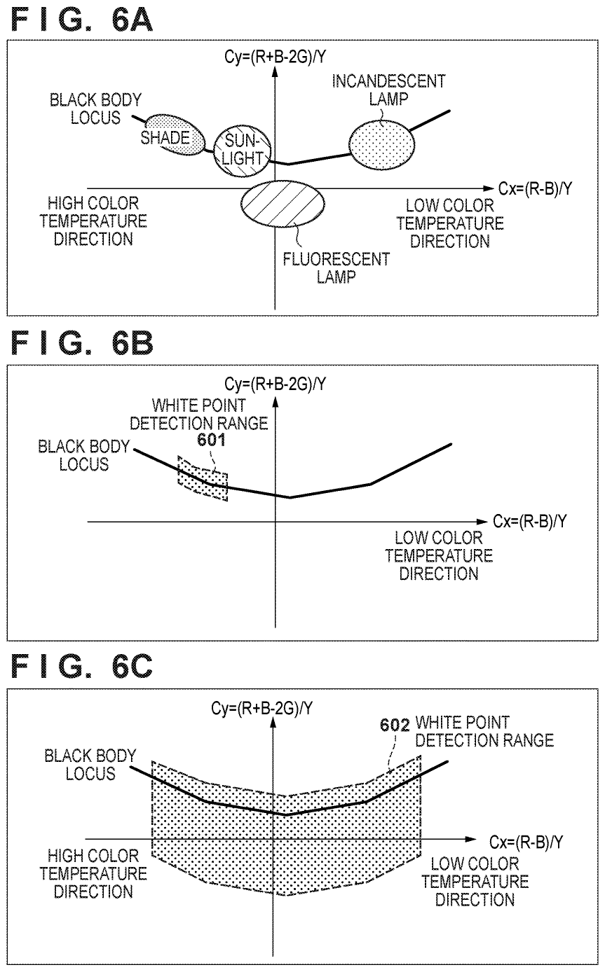

FIG. 6A shows ranges of white regions corresponding to the illuminant types in a CxCy color space. Note that the relationship between the RGB values and the coordinates of the CxCy color space is as follows.

$$Cx = ( R - B ) / Y \times 1024$$

$$Cy = ( R + B - 2 G ) / Y \times 1024$$

$$where Y = ( R + 2 G + B ) / 4$$

The negative direction of the x coordinate (Cx) represents the color evaluation value of an image of a high color temperature object (e.g., an image of a white object captured in the shade under a clear sky), and the positive direction thereof represents the color evaluation value of an image of a low color temperature object (e.g., an image of a white object captured under an incandescent lamp illuminant). The difference from the black body locus on the y coordinate (Cy) corresponds to the color deviation (Δuv). In the CxCy color space, a green component becomes greater if Δuv is negative (located downward of the black body locus), and a reddish purple component becomes greater if Δuv is positive (located upward of the black body locus). Therefore, the color evaluation value of a commonly used fluorescent lamp is in a range where Δuv is negative.

In a case where an illuminant type is output as the illuminant estimation information 305, the WB control unit 203 sets the white point detection range according to the corresponding one of the illuminant types shown in FIG. 6A. In a case where an illuminant color temperature and Δuv are output as the illuminant estimation information 305, the WB control unit 203 specifies an illuminant type from the relationship therebetween, and sets the white point detection range corresponding to the specified illuminant type.

In a case where the reliability of the illuminant estimation information is provided, the WB control unit 203 can change the size of the white point detection range to be set, according to that reliability.

For example, let us assume that the illuminant type is estimated to be the shade under a clear sky. If the reliability of the estimation is greater than or equal to a threshold (high), the WB control unit 203 sets, as shown in FIG. 6B, a white point detection range 601 that is substantially the same as the white range for the shade under a clear sky in FIG. 6A. On the other hand, if the reliability of the estimation is less than the threshold (low), the WB control unit 203 sets, as shown in FIG. 6C, a wide white point detection range 602 corresponding to a plurality of types of ambient illuminants such that white ranges for other types of illuminants can also be detected. The white point detection range 602 can be defined from color evaluation values obtained by capturing images of a white object under different illuminants in advance and calculating the color evaluation values thereof.

In S502, the WB control unit 203 divides image data of one frame that has been output by the demosaic processing unit 201 and been stored in the memory 106 into m (>1) blocks.

In S503, the WB control unit 203 averages, for each block, the values of the pixels included in the block for each color component, to calculate a color average value (R[i], G[i], B[i]). Then, the color components of the color average value are assigned to R, G, and B in the above-described expression, to calculate a color evaluation value (Cx[i], Cy[i]) for each block. Note that i is a block number, and is an integer from 1 to m.

In S504, the WB control unit 203 determines whether the color evaluation value (Cx[i], Cy[i]) of the i-th block calculated in S503 is included in the white point detection range set in S501, executes S505 if it is determined that the color evaluation value is included, and executes S506 otherwise.

In S505, the WB control unit 203 integrates, for each block for which it is determined that the color evaluation value (Cx[i], Cy[i]) is included in the white point detection range, a color average value for each color component (R[i], G[i], B[i]).

Note that the processing in S504 and S505 can be represented by the following expressions:

$$SumR = {\sum }_{i = 0}^{m} Sw ⌈ i ⌉ \times R [ i ]$$

$$SumG = {\sum }_{i = 0}^{m} Sw ⌈ i ⌉ \times G [ i ]$$

$$SumB = {\sum }_{i = 0}^{m} Sw ⌈ i ⌉ \times B [ i ]$$

In the expressions, Sw[i] is a variable that takes the value 1 for a block for which it is determined, in S504, that the color evaluation value (Cx[i], Cy[i]) is included in the white point detection range, and takes the value 0 for a block for which it is not thus determined.

In S506, the WB control unit 203 determines whether the processing in and after S503 has been executed for all of the blocks, and executes S507 if it is determined that the processing has been executed, and otherwise, the WB control unit 203 executes the processing in and after S503 for one block that has not undergone the processing.

In S507, the WB control unit 203 calculates, from the integral value (SumR, SumG, SumB) of the color average values, a white balance correction value WBCo (WBCo_R, WBCo_G, WBCo_B) in accordance with the following expressions, and ends the processing for calculating the WB correction value. The white balance correction value WBCo is a white balance correction value used for auto white balance adjustment processing.

$$WBCo\_R = SumY \times 1024 / SumR$$

$$WBCo\_G = SumY \times 1024 / SumG$$

$$WBCo\_B = SumY \times 1024 / SumB$$

$$where SumY = ( SumR + 2 \times SumG + SumB ) / 4$$

### Modification

Here, in a case where the reliability of the illuminant estimation information is high, a relatively narrow white point detection range is set according to the illuminant type. However, the WB correction value may be modified such that the color evaluation values of pixels to which the WB correction values calculated by setting a wide white point detection range as the white point detection range 602 shown in FIG. 6C are applied are within a white point detection range (e.g., the white point detection range 601) based on the illuminant estimation information.

According to the embodiment, illuminant estimation is performed using an image for which white balance adjustment has been performed using a fixed white balance correction value, thus enabling illuminant estimation to be performed with stable accuracy without depending on a region of a specific object or a region of a specific color.

### Second Embodiment

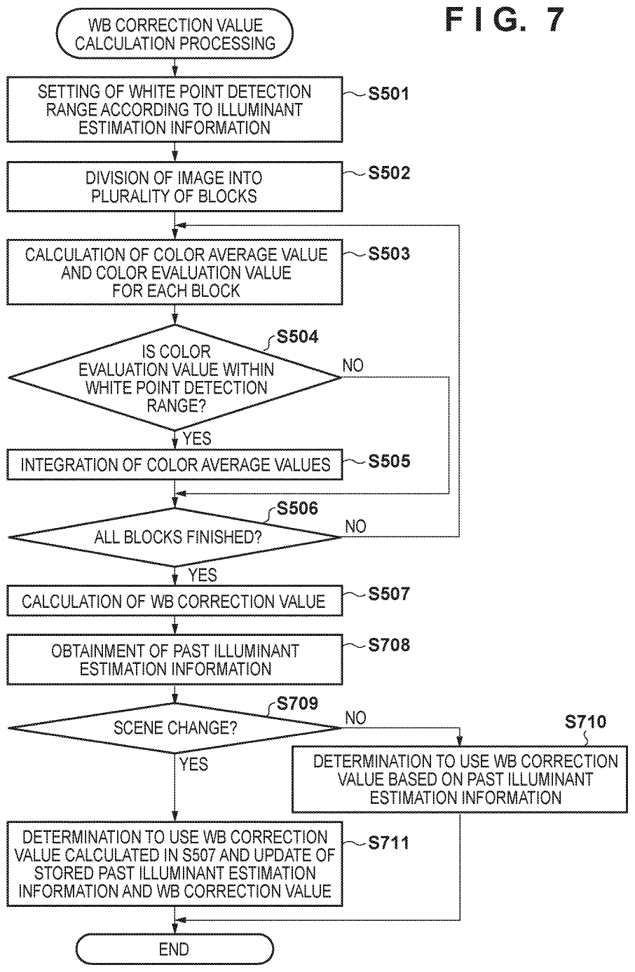

Next, a second embodiment will be described. The embodiment is the same as the first embodiment except for the WB correction value calculation processing. Therefore, the WB correction value calculation processing according to the embodiment will be described with reference to the flowchart shown in FIG. 7.

The processing from S501 to S507 is similar to that of the first embodiment, and therefore the description thereof has been omitted.

In S708, the WB control unit 203 obtains illuminant estimation information that was obtained by the DL unit 202 in the past and stored in the non-volatile memory 121, for example. If the illuminant estimation information is not stored, the WB control unit 203 executes S711.

Note that, if the difference between the date and time of obtainment of the stored illuminant estimation information and the current date and time exceeds a threshold, the WB control unit 203 may execute S711 without obtaining past illuminant estimation information. Alternatively, in one embodiment, past illuminant estimation information may be obtained only in a case where a condition is satisfied, such as a case where still images are being consecutively captured, or where a moving image is being captured.

In S709, the WB control unit 203 determines whether a scene change occurred. Specifically, the WB control unit 203 compares the past illuminant estimation information obtained in S708 and the most recent illuminant estimation information obtained in S501, and determines that a scene change occurred if the illuminant type has changed, or if the difference between the color temperatures or the color deviations (Δuv) is greater than or equal to a threshold. The WB control unit 203 executes S711 if it is determined that a scene change occurred, and executes S710 otherwise.

In S710, the WB control unit 203 determines to use the WB correction value based on the past illuminant estimation information obtained in S708 for white balance adjustment by the WB control unit 203. Then, the WB control unit 203 obtains the WB correction value based on the past illuminant estimation information stored in the non-volatile memory 121, for example.

In S711, the WB control unit 203 determines to use the WB correction value (the most recent WB correction value) calculated in S507 for white balance adjustment by the WB control unit 203. Then, the WB control unit 203 updates the past illuminant estimation information stored in the non-volatile memory 121 and the WB correction value based on the past illuminant estimation information with the most recent illuminant estimation information and the most recent WB correction value, respectively.

According to the embodiment, the same WB correction value continues to be used unless it is determined that a scene change occurred, and it is therefore possible to suppress variations in white balance. Accordingly, the embodiment is particularly useful in a case where images of a plurality of associated frames are captured over time, such as consecutive capturing of still images and capturing of a moving image.

Note that, instead of directly using a past WB correction value, a WB correction value obtained by performing weighted addition (e.g., averaging) on the most recent WB correction value and a past WB correction value may be used.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-059134, filed Mar. 31, 2025, which is hereby incorporated by reference herein in its entirety.

What is claimed is:

1. An apparatus comprising one or more processors that execute a program stored in a memory and thereby cause the one or more processors to:
execute, on second image data obtained by executing demosaic processing on first image data, adjustment processing using a first correction value to obtain third image data, wherein the first correction value is not dependent on the second image data;
estimate, based on the third image data, information relating to an ambient illuminant of a capturing scene of the first image data; and
obtain, based on the estimated information relating to the ambient illuminant and on the second image data, a second correction value to be used for execution of adjustment processing on the second image data.

2. The apparatus according to claim 1, wherein
the information relating to the ambient illuminant is estimated using a trained machine learning model, and the machine learning model was trained through supervised learning performed using image data on which adjustment processing using the first correction value had been executed.

3. The apparatus according to claim 1, wherein
the first correction value is a correction value assuming a specific ambient illuminant.

4. The apparatus according to claim 1, wherein
one or more of a type of the ambient illuminant, a color temperature of the ambient illuminant, and a color deviation (Δuv) of the ambient illuminant is estimated as the information relating to the ambient illuminant.

5. The apparatus according to claim 4, wherein
the one or more processors further output a reliability of the estimated information relating to the ambient illuminant.

6. The apparatus according to claim 5, wherein,
when obtaining the second correction value, a white point detection range to be set is changed according to the reliability of the information relating to the ambient illuminant.

7. The apparatus according to claim 1, wherein
the second correction value is obtained by modifying, based on the estimated information relating to the ambient illuminant, a third correction value obtained for the second image data by setting a white point detection range corresponding to a plurality of types of ambient illuminants.

8. The apparatus according to claim 1, wherein
the one or more processors further:
determine whether a scene change occurred between a capturing scene of most recent first image data and a past capturing scene, and
determine the second correction value to be used for execution of adjustment processing on most recent second image data obtained by executing demosaic processing on the most recent first image data to be:
a correction value obtained for the most recent second image data if it is determined that the scene change occurred; and
a previously obtained correction value if it is not determined that the scene change occurred.

9. An apparatus comprising:
an image sensor; and
an apparatus comprising one or more processors that execute a program stored in a memory and thereby cause the one or more processors to:
execute, on second image data obtained by executing demosaic processing on first image data, adjustment processing using a first correction value to obtain third image data, wherein the first correction value is not dependent on the second image data;
estimate, based on the third image data, information relating to an ambient illuminant of a capturing scene of the first image data; and
obtain, based on the estimated information relating to the ambient illuminant and on the second image data, a second correction value to be used for execution of adjustment processing on the second image data,
wherein after demosaic processing is executed on the first image data captured using the image sensor, adjustment processing is executed on the first image data using the second correction value obtained by the apparatus.

10. A method to be executed by an apparatus, the method comprising:
executing, on second image data obtained by executing demosaic processing on first image data, adjustment processing using a first correction value to obtain third image data, wherein the first correction value to obtain third image data, wherein the first correction value is not dependent on the second image data;
estimating, based on the third image data, information relating to an ambient illuminant of a capturing scene of the first image data; and
obtaining, based on the estimated information relating to the ambient illuminant and on the second image data, a second correction value to be used for execution of adjustment processing on the second image data.

11. The method according to claim 10, wherein
the information relating to the ambient illuminant is estimated using a trained machine learning model, and the machine learning model was trained through supervised learning performed using image data on which adjustment processing using the first correction value had been executed.

12. The method according to claim 10, wherein
the first correction value is a correction value assuming a specific ambient illuminant.

13. The method according to claim 10, wherein
one or more of a type of the ambient illuminant, a color temperature of the ambient illuminant, and a color deviation (Δuv) of the ambient illuminant is estimated as the information relating to the ambient illuminant.

14. The method according to claim 10, wherein
the second correction value is obtained by modifying, based on the estimated information relating to the ambient illuminant, a third correction value obtained for the second image data by setting a white point detection range corresponding to a plurality of types of ambient illuminants.

15. A non-transitory computer-readable medium storing a program for causing a computer to execute a method comprising:
executing, on second image data obtained by executing demosaic processing on first image data, adjustment processing using a first correction value to obtain third image data, wherein the first correction value to obtain third image data, wherein the first correction value is not dependent on the second image data;
estimating, based on the third image data, information relating to an ambient illuminant of a capturing scene of the first image data; and
obtaining, based on the estimated information relating to the ambient illuminant and on the second image data, a second correction value to be used for execution of adjustment processing on the second image data.

16. The method according to claim 15, wherein
the information relating to the ambient illuminant is estimated using a trained machine learning model, and the machine learning model was trained through supervised learning performed using image data on which adjustment processing using the first correction value had been executed.

17. The method according to claim 15, wherein
the first correction value is a correction value assuming a specific ambient illuminant.

18. The method according to claim 15, wherein
one or more of a type of the ambient illuminant, a color temperature of the ambient illuminant, and a color deviation (Δuv) of the ambient illuminant is estimated as the information relating to the ambient illuminant.

19. The method according to claim 15, wherein
the second correction value is obtained by modifying, based on the estimated information relating to the ambient illuminant, a third correction value obtained for the second image data by setting a white point detection range corresponding to a plurality of types of ambient illuminants.
